(19) United States
(12) Patent Application Publication
(10) Pub. No.: US 2023/0252763 A1
(43) Pub. Date: Aug. 10, 2023

(54) MODEL GENERATION METHOD, MODEL GENERATION DEVICE, AND INFERENCE DEVICE

(71) Applicant: TOYOTA JIDOSHA KABUSHIKI KAISHA, Aichi-ken (JP)

(72) Inventors: Hiroyasu YAMASHITA, Toyota-shi (JP); Satoshi MIYAKE, Toyota-shi (JP); Akifumi YAMADA, Toyota-shi (JP)

(21) Appl. No.: 17/991,854

(22) Filed: Nov. 22, 2022

(30) Foreign Application Priority Data
Feb. 9, 2022 (JP) 2022-018376

(51) Int. Cl. G06V 10/774; G06V 10/776; G06V 10/80; G06V 20/56; G06V 10/771; G06V 10/82

(52) U.S. Cl. CPC G06V 10/774; G06V 10/80; G06V 10/82; G06V 10/771; G06V 10/776; G06V 20/56

(57) ABSTRACT

A model generation method according to the present disclosure is an information processing method executed by a computer, and includes implementing machine learning of an inference model using a plurality of training images. The inference model includes a compression module and an inference module configured to infer a solution of a task for a subregion in an input image. The compression module is configured to generate compression information by compressing information on an extensive region that includes the subregion and is wider than the subregion. The inference module is configured to derive the solution of the task from information on the subregion and the compression information obtained by the compression module.

### CROSS-REFERENCE TO RELATED APPLICATION

This application claims priority to Japanese Patent Application No. 2022-018376 filed on Feb. 9, 2022, incorporated herein by reference in its entirety.

### BACKGROUND

### 1. Technical Field

The present disclosure relates to a model generation method, a model generation device, and an inference device.

### 2. Description of Related Art

Japanese Unexamined Patent Application Publication No. 2019-8383 (JP 2019-8383 A) proposes an image processing device that executes image processing using information in a multi-resolution representation. Specifically, the image processing device uses a first convolutional neural network to convert an input image into a first feature quantity. The image processing device uses a second convolutional neural network to convert the input image into a second feature quantity. Moreover, the image processing device uses a third convolutional neural network to convert a third feature quantity generated by the addition of the first feature quantity and the second feature quantity into an output image.

### SUMMARY

The present disclosure is to provide a technique of improving the accuracy of inference for a subregion in an input image.

A first aspect of the present disclosure relates to a model generation method that is an information processing method executed by a computer. The information processing method includes acquiring a plurality of training images, and implementing machine learning of an inference model using the acquired training images. The inference model includes a compression module and an inference module configured to infer a solution of a task for a subregion in an input image. The compression module is configured to generate compression information by acquiring information on an extensive region that includes the subregion and is wider than the subregion from the input image and compressing the acquired information on the extensive region. The inference module is configured to derive the solution of the task from information on the subregion obtained from the input image and the compression information obtained by the compression module. Implementing the machine learning includes training the inference model such that a result of inference obtained by the inference model by inputting each of the training images to the inference model as the input image matches a correct answer of the task for the subregion in each of the training images.

A second aspect of the present disclosure relates to a model generation device. The model generation device includes a controller. The controller is configured to execute acquiring the training images, and implementing machine learning of an inference model using the acquired training images. The inference model includes a compression module and an inference module configured to infer a solution of a task for a subregion in an input image. The compression module is configured to generate compression information by acquiring information on an extensive region that includes the subregion and is wider than the subregion from the input image and compressing the acquired information on the extensive region. The inference module is configured to derive the solution of the task from information on the subregion obtained from the input image and the compression information obtained by the compression module. Implementing the machine learning includes training the inference model such that a result of inference obtained by the inference model by inputting each of the training images to the inference model as the input image matches a correct answer of the task for the subregion in each of the training images.

A third aspect of the present disclosure relates to an inference device. The inference device includes a controller. The controller is configured to execute acquiring a target image, and inferring a solution of a task for the acquired target image using an inference model that has been trained through machine learning. The inference model includes a compression module and an inference module configured to infer a solution of a task for a subregion in an input image. The compression module is configured to generate compression information by acquiring information on an extensive region that includes the subregion and is wider than the subregion from the input image and compressing the acquired information on the extensive region. The inference module is configured to derive the solution of the task from information on the subregion obtained from the input image and the compression information obtained by the compression module. Inferring the solution of the task for the target image includes acquiring a result obtained by inputting the target image to the inference model that has been trained, as the input image, and inferring the solution of the task from the inference model that has been trained.

A fourth aspect of the present disclosure relates to a storage medium that stores an interference program. The inference program causes a computer to execute an information processing method. The information processing method includes acquiring a target image, and inferring a solution of a task for the acquired target image using an inference model that has been trained through machine learning. The inference model includes a compression module and an inference module configured to infer a solution of a task for a subregion in an input image. The compression module is configured to generate compression information by acquiring information on an extensive region that includes the subregion and is wider than the subregion from the input image and compressing the acquired information on the extensive region. The inference module is configured to derive the solution of the task from information on the subregion obtained from the input image and the compression information obtained by the compression module. Inferring the solution of the task for the target image includes acquiring a result obtained by inputting the target image to the inference model that has been trained, as the input image, and inferring the solution of the task from the inference model that has been trained.

According to the present disclosure, it is possible to improve the accuracy of inference for the subregion in the input image.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 schematically shows an example of a scene to which the present disclosure is applied;

FIG. 2 schematically shows an example of a configuration of an inference model according to an embodiment;

FIG. 3 schematically shows an example of operation processing of a compression module according to the embodiment;

FIG. 4 schematically shows an example of a hardware configuration of a model generation device according to the embodiment;

FIG. 5 schematically shows an example of a hardware configuration of an inference device according to the embodiment;

FIG. 6 schematically shows an example of a software configuration of the model generation device according to the embodiment;

FIG. 7 schematically shows an example of a software configuration of the inference device according to the embodiment;

FIG. 8 is a flowchart showing an example of a processing procedure of the model generation device according to the embodiment;

FIG. 9 is a flowchart showing an example of a processing procedure of the inference device according to the embodiment;

FIG. 10 shows a result of inference of Comparative Example for an evaluation image; and

FIG. 11 shows a result of inference of Example for the evaluation image.

### DETAILED DESCRIPTION OF EMBODIMENTS

With a method in the related art, it can be expected that the accuracy of inference processing for an input image is improved using information in a multi-resolution representation. On the other hand, for example, the input image may be divided into subregions and the inference processing may be executed for the subregions due to reasons, such as a size of the input image and restrictions on the operation capacity of a computer. As a result, a range referred to in the inference processing can be reduced, so that a load of the operation processing can be suppressed and the efficiency can be improved.

However, a feature that appears in the subregion may have a relation with a feature that is present outside the subregion. For example, a scene in which a curvature of each part of an object is estimated will be assumed. In this scene, in a case where a target portion in the subregion has a gentle curvature, a shape of the object extending from the outside of the subregion to the target portion may be useful for estimating the curvature of the target portion.

That is, information useful for inferring the feature that appears in the subregion may be present outside the subregion. With the method in the related art, it is possible to refer to the information in the subregion in the multi-resolution representation, but it is difficult to refer to the information present outside the subregion. As a result, in a case where the inference processing is executed for the subregion, there is a probability that the accuracy of inference is deteriorated.

On the other hand, a model generation method according to one aspect of the present disclosure is an information processing method executed by a computer, the information processing method including acquiring a plurality of training images, and implementing machine learning of an inference model using the acquired training images. The inference model includes a compression module and an inference module configured to infer a solution of a task for a subregion in an input image. The compression module is configured to generate compression information by acquiring information on an extensive region that includes the subregion and is wider than the subregion from the input image and compressing the acquired information on the extensive region. The inference module is configured to derive the solution of the task from information on the subregion obtained from the input image and the compression information obtained by the compression module. Implementing the machine learning includes training the inference model such that a result of inference obtained by the inference model by inputting each of the training images to the inference model as the input image matches a correct answer of the task for the subregion in each of the training images.

In addition, an inference device according to another aspect of the present disclosure includes a controller configured to execute acquiring a target image, and inferring a solution of a task for the acquired target image using an inference model that has been trained through machine learning. The inference model includes a compression module and an inference module configured to infer a solution of a task for a subregion in an input image. The compression module is configured to generate compression information by acquiring information on an extensive region that includes the subregion and is wider than the subregion from the input image and compressing the acquired information on the extensive region. The inference module is configured to derive the solution of the task from information on the subregion obtained from the input image and the compression information obtained by the compression module. Inferring the solution of the task for the target image includes acquiring a result obtained by inputting the target image to the inference model that has been trained, as the input image, and inferring the solution of the task from the inference model that has been trained.

According to each aspect of the present disclosure, in the inference processing, the inference model is configured to refer to the compression information obtained by the compression module as the information on the extensive region including a region outside the subregion, in addition to the information on the subregion in the input image. As a result, the feature that appears in the subregion can be inferred based on the feature present outside the subregion, so that the accuracy of the inference processing can be expected to be improved. Therefore, with the model generation method according to one aspect of the present disclosure, it is possible to generate the inference model that has been trained and can execute the inference processing with high accuracy. With the inference device according to another aspect of the present disclosure, it is possible to improve the accuracy of the inference processing for the subregion in the input image by using such an inference model that has been trained.

In the following, an embodiment related to one aspect of the present disclosure (hereinafter, also referred to as “the present embodiment”) will be described with reference to the drawings. It should be noted that the present embodiment described below is merely an example of the present disclosure in all respects. Various improvements or modifications may be made without departing from the scope of the present disclosure. In a case of implementing the present disclosure, a specific configuration according to the embodiment may be appropriately adopted. It should be noted that data appearing in the present embodiment is described in natural language, but more specifically, the data is designated in pseudo language, a command, a parameter, machine language, or the like that can be recognized by the computer.

### 1 Application Example

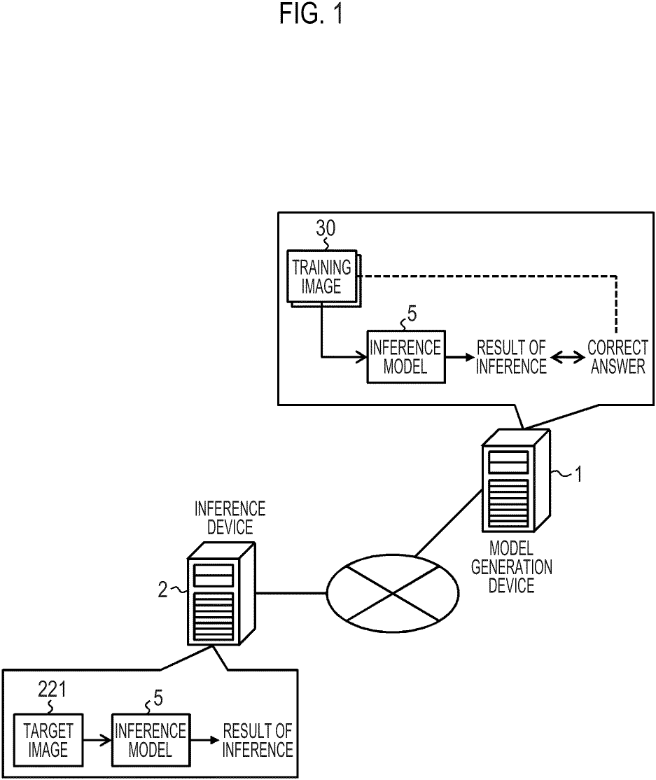

FIG. 1 schematically shows an example of the scene to which the present disclosure is applied. An inference system according to the present embodiment includes a model generation device 1 and an inference device 2.

The model generation device 1 according to the present embodiment is one or more computers configured to generate an inference model 5 that has been trained by implementing the machine learning. Specifically, the model generation device 1 acquires a plurality of training images 30. The model generation device 1 implements the machine learning of the inference model 5 using the acquired training images 30. As a result, the model generation device 1 generates the inference model 5 that has been trained.

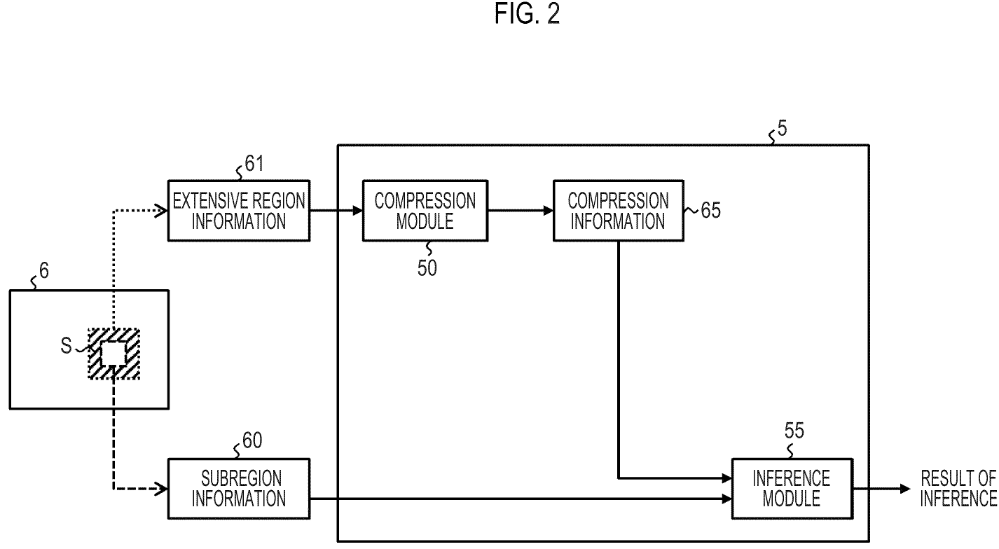

FIG. 2 schematically shows an example of a configuration of the inference model 5 according to the present embodiment. The inference model 5 according to the present embodiment includes a compression module 50 and an inference module 55 that infers a solution of a task for a subregion in an input image 6. The compression module 50 is configured to acquire extensive region information 61 of an extensive region that includes the subregion and is wider than the subregion from the input image 6. Further, the compression module 50 is configured to generate compression information 65 by compressing the acquired extensive region information 61. The inference module 55 is configured to derive the solution of the task from subregion information 60 of the subregion obtained from the input image 6 and the compression information 65 obtained by the compression module 50.

As shown in FIG. 1, implementing the machine learning includes training the inference model 5 such that a result of inference obtained by the inference model 5 by inputting each training image 30 to the inference model 5 as the input image 6 matches a correct answer of the task for the subregion in each training image 30. Through this machine learning, it is possible to generate the inference model 5 that has been trained and has acquired the capacity to perform an inference task on the subregion in the image.

On the other hand, as shown in FIG. 1, the inference device 2 according to the present embodiment is one or more computers configured to infer the solution of the task for the subregion in the image by using the inference model 5 that has been trained. Specifically, the inference device 2 acquires a target image 221. The inference device 2 infers the solution of the task for the acquired target image 221 by using the inference model 5 that has been trained through the machine learning.

As shown in FIGS. 1 and 2, inferring the solution of the task for the target image 221 includes acquiring the result obtained by inputting the target image 221 to the inference model 5 that has been trained, as the input image 6, and inferring the solution of the task from the inference model 5 that has been trained. As a result of this operation processing, the inference device 2 can obtain the result obtained by inferring the solution of the task for the target image 221. Moreover, the inference device 2 outputs information on the result obtained by inferring the solution of the task.

As described above, in the present embodiment, the inference model 5 includes the compression module 50. As a result, in the inference processing of the inference module 55, the inference model 5 can refer to information (compression information 65) on the extensive region including a region outside the subregion, in addition to the subregion information 60 of the input image 6. As a result, the feature that appears in the subregion can be inferred based on the feature present outside the subregion, so that the accuracy of the inference processing can be expected to be improved. Therefore, with the model generation device 1 according to the present embodiment, it is possible to generate the inference model 5 that has been trained and can execute the inference processing with high accuracy. With the inference device 2 according to the present embodiment, it is possible to improve the accuracy of the inference processing for the subregion in the input image 6 (target image 221) by using such an inference model 5 that has been trained.

It should be noted that a data format of the image (training image 30 and target image 221) does not have to be particularly limited, and may be appropriately selected in accordance with the embodiment. The image may be composed of general image data composed of a plurality of pixels, as well as data that can be output in an image format, such as point cloud data computer aided design (CAD) data, map data, and simulation data.

The image may be obtained by a sensor, such as a camera, light detection and ranging or laser imaging detection and ranging (LiDAR), a millimeter wave radar, an infrared sensor, or an ultrasonic sensor. The image may be generated by a computer operation. The image may be generated by operation processing of the computer, such as simulation (for example, fluid, temperature, heat flow rate, and strain), or computer aided engineering (CAE). The image may be obtained by simulating an operation of the sensor. The training image 30 may be obtained by applying any operation processing (for example, processing related to data expansion) to the data obtained by any method. The processing related to the data expansion may be, for example, rotation processing or translation processing. The image may be configured to represent a two-dimensional space or a three-dimensional space.

The compression module 50 does not have to be particularly limited as long as operation processing of generating the compression information 65 from the extensive region information 61 can be executed, and may be appropriately configured in accordance with the embodiment. In one example, the compression module 50 may be composed of a machine learning model including one or more parameters for executing the operation processing of generating the compression information 65 from the extensive region information 61, the one or more parameters having values adjusted through the machine learning. A type of the machine learning model constituting the compression module 50 does not have to be particularly limited, and may be appropriately selected in accordance with the embodiment. For the machine learning model constituting the compression module 50, for example, a neural network may be used. A structure of the neural network (for example, the number of layers, a type of each layer, the number of nodes included in each layer, or a connection relationship between the nodes of the layers) may be appropriately determined in accordance with the embodiment. In a case where the neural network is used for the compression module 50, the weight of the connection between each node, a threshold value of each node, and the like are examples of the parameters of the compression module 50.

In addition, the inference module 55 does not have to be particularly limited as long as operation processing of deriving the solution of the task from the subregion information 60 and the compression information 65 can be executed, and may be appropriately configured in accordance with the embodiment. In the present embodiment, the inference module 55 may be composed of a machine learning model including one or more parameters for executing the operation processing of deriving the solution of the task from the subregion information 60 and the compression information 65. the one or more parameters having values adjusted through the machine learning. A type of the machine learning model constituting the inference module 55 does not have to be particularly limited, and may be appropriately selected in accordance with the embodiment. For the machine learning model constituting the inference module 55, for example, a neural network may be used. A structure of the neural network constituting the inference module 55 may be appropriately determined in accordance with the embodiment. In a case where the neural network is used for the inference module 55, the weight of the connection between each node, the threshold value of each node, and the like are examples of the parameters of the inference module 55. A format of the output of the inference module 55 does not have to be particularly limited as long as the output shows the result of inference, and may be appropriately determined in accordance with the embodiment.

It should be noted that, in a case where both the compression module 50 and the inference module 55 are composed of the machine learning model, the compression module 50 and the inference module 55 may be integrally configured. In addition, training the inference model 5 by the model generation device 1 may include adjusting the values of the one or more parameters of the compression module 50 and the inference module 55 such that the result of inference obtained by the inference model 5 by inputting each training image 30 to the inference model 5 as the input image 6 matches the correct answer of the task for each training image 30.

A content of compression processing of the information by the compression module 50 does not have to be particularly limited as long as the compression processing is processing of reducing a data size of the extensive region information 61, and may be appropriately determined in accordance with the embodiment. In one example, the compression module 50 may be configured to obtain the compression information 65 by simple compression processing. In another example, the compression module 50 may be configured to obtain the compression information 65 through reduction and restoration of the data.

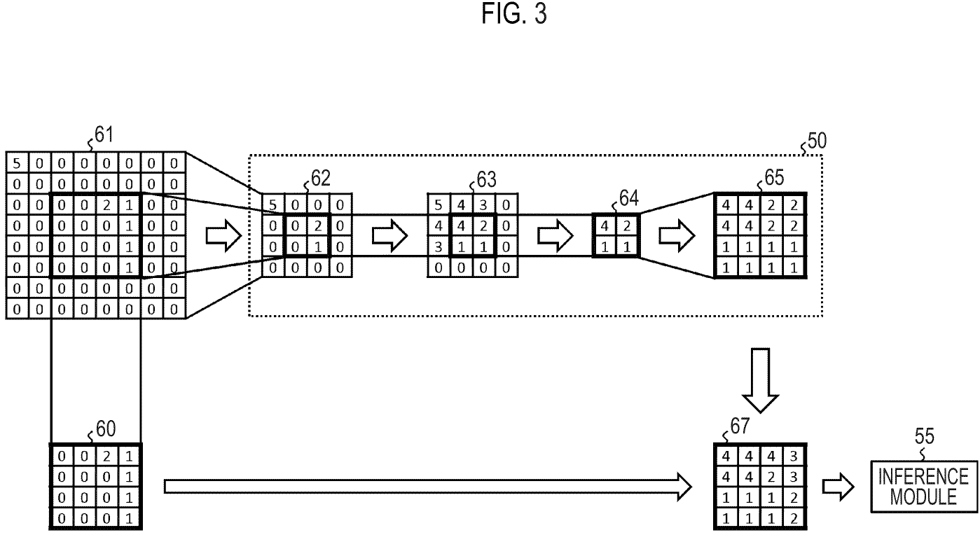

FIG. 3 schematically shows an example of the operation processing of the compression module 50 according to the present embodiment. It should be noted that, in FIG. 3, for convenience of description, the subregion information 60 is represented by 4 × 4 data, and the extensive region information 61 is represented by 8 × 8 data. The extensive region (8 × 8) includes the subregion (4 × 4) in the center. These representations are merely examples and do not limit the present disclosure.

In the example of FIG. 3, first, the compression module 50 reduces a size of the extensive region information 61 (8 × 8) by executing a pooling operation in a size of 2 × 2, and obtains the information 62 having the same size (4 × 4) as the subregion information 60. In the information 62, a 2 × 2 region in the center corresponds to the subregion after the pooling operation. Next, the compression module 50 obtains information 63 by averaging the respective values included in the information 62 by a convolution operation. Subsequently, the compression module 50 obtains information 64 having a size of 2 × 2 by cutting out the 2 × 2 region in the center in the information 63. Moreover, the compression module 50 obtains the compression information 65 having a size of 4 × 4 by executing an amplifiering (upsampling) operation with a size of 2 × 2. Although the compression processing of FIG. 3 includes the operation of cutting out the 2 × 2 region, the pooling operation and the convolution operation are included before the cutout operation, so that the obtained compression information 65 can represent the features of the entire extensive region.

The pooling operation can be executed by a pooling layer. The convolution operation can be executed by a convolutional layer. The amplifiering operation can be executed by amplifiering. Therefore, as an example, the compression module 50 may be composed of a neural network having three layers of the pooling layer, the convolutional layer, and the amplifiering layer. As a result, the compression module 50 may be configured to execute the operation processing shown in FIG. 3. It should be noted that the content of the compression processing does not have to be limited to such an example. The processing content of FIG. 3 may be appropriately changed in accordance with the embodiment.

It should be noted that the number of dimensions (information amount, compression rate, and data size) of the compression information 65 does not have to be particularly limited, and may be appropriately determined in accordance with the embodiment. In one example, the compression information 65 may be configured in the same dimension as the subregion. That is, the compression module 50 may be configured to generate the compression information 65 having the same dimension as the subregion. Specifically, as shown in FIG. 3, the compression information 65 may be configured to represent a spatial region having the same size (same number of elements and same spatial range) as the subregion.

In this case, the compression information 65 may be integrated with the subregion information 60 before the inference processing is executed. That is, as shown in FIG. 3, the inference module 55 may be configured to generate integrated information 67 by integrating the subregion information 60 and the compression information 65, and derive the solution of the task from the generated integrated information 67. With the configuration in which the integrated information 67 is processed, the number of parameters of the inference module 55 can be reduced as compared with a case where the subregion information 60 and the compression information 65 are processed separately. As a result, the efficiency of the inference processing can be improved. It should be noted that integration processing may be composed of any processing, such as addition, averaging, weighted averaging, and addition as information of another dimension (for example, addition of a channel of a feature map).

The subregion is a part of the regions in the input image 6. The subregion may be appropriately designated in the input image 6. In one example, the inference model 5 may repeatedly execute the inference processing for the input image 6 while changing a range designated as the subregion (for example, shifting the range by a predetermined amount). That is, the input image 6 may be divided into a plurality of ranges, and the inference model 5 may designate each range of the input image 6 as the subregion and execute the inference processing for each subregion (range). As a result, the inference model 5 may be configured to execute the inference processing for the ranges (for example, the entire range) of the input image 6. It should be noted that the processing range of the inference model 5 does not have to be limited to such an example. The inference model 5 does not have to execute the inference processing for a part of the ranges of the input image 6. It should be noted that, in a case where a plurality of subregions is designated in the input image 6, at least some subregions of the subregions may be designated to overlap with the adjacent subregions. Alternatively, the subregions may be designated not to overlap with each other.

The extensive region is a region that includes the subregion and is wider than the subregion. The extensive region may be designated by expanding the subregion in any direction. The direction of expansion does not have to be particularly limited, and may be appropriately selected in accordance with the embodiment. As an example, candidates for the direction of expansion are four directions (up, down, right, and left) in a case of the two-dimensional space, and six directions (up, down, right, left, front, and back) in a case of the three-dimensional space. The extensive region may be designated by selecting the direction of expanding the subregion from a plurality of candidates for the expandable direction, and expanding the subregion in the selected direction. In one example, the extensive region may be designated by expanding the subregion in the directions of some of the candidates in the expandable direction.

In another example, as shown in FIG. 2, the extensive region may be configured to include a peripheral region S that surrounds the entire periphery of the subregion. That is, the extensive region may be designated by expanding the subregion in all expandable directions. In this case, as shown in FIG. 3, the extensive region may be designated to include the subregion in the center by expanding the subregion evenly in all directions. It should be noted that a method of designating the extensive region does not have to be limited to such an example. In another example, an amount of expansion of the subregion may be biased in some directions. As described above, with the configuration in which the extensive region includes the peripheral region S, information can be obtained from all directions around the subregion. As a result, in the inference processing of the inference model 5, the probability of missing the information of the feature having a relation with the feature that appears in the subregion can be reduced, so that the accuracy of the inference processing can be expected to be improved. It should be noted that an order of designating each of the subregion and the extensive region does not have to be particularly limited. In one example, the extensive region may be designated after the subregion is designated. In another example, the extensive region may be designated after the subregion is designated.

A size of the extensive region does not have to be particularly limited, and may be appropriately determined in accordance with the embodiment. In one example, the size of the extensive region may be within eight times a size of the subregion. By setting an upper limit on the size of the extensive region in this way, it is possible to suppress an increase in an operation load and a cost of the compression processing by the compression module 50. so that the processing efficiency of the inference model 5 can be improved.

The subregion information 60 and the extensive region information 61 may be appropriately acquired from the input image 6. As shown in FIG. 3, each information (60, 61) may indicate a feature quantity of each element (for example, pixel or point) included in each region. The feature quantity may be, for example, a pixel value, a measurement value, a value indicating the presence probability, or a value calculated by any operation processing. In one example, each information (60, 61) may be acquired directly from the input image 6. In another example, each information (60, 61) may be acquired by executing any operation processing for the input image 6.

A type of the task does not have to be particularly limited as long as the task is to infer the feature that appears in the subregion in the image (for example, the attribute of the object that appears in the range), and may be appropriately selected in accordance with the embodiment. The inference may be identification or regression. The inference may include prediction. A type of the image may be appropriately selected in accordance with the task.

In one example, each training image 30 and the target image 221 may show the object. The task may be to infer the attribute of the object that appears in the subregion. As a result, in the scene of inferring the attribute of the object, the accuracy of the inference processing can be improved. It should be noted that, as an example of an application scene, the task of inferring the attribute of the object may be adopted in the scene of inspecting an article. In this case, the attribute of the article that is an inference target may be, for example, an R value, states of other parts, or the presence or absence of defects. As another example, the task of inferring the attribute of the object may be adopted in a scene in which the object is measured by an in-vehicle sensor. In this case, the in-vehicle sensor may be disposed toward an inside of a vehicle, and the object may be present in the vehicle, such as an occupant. Alternatively, the in-vehicle sensor may be disposed toward an outside of the vehicle, and the object may be present outside the vehicle, such as an obstacle (person or object), and a traffic-related object (for example, a road surface and a traffic light). The attribute of the object may be, for example, a state of the occupant, a state of the obstacle, or a state of the road surface.

In another example, each training image 30 and the target image 221 may be obtained by the in-vehicle sensor. The in-vehicle sensor may be, for example, a camera, a LiDAR, a millimeter wave radar, an infrared sensor, or an ultrasonic sensor. The task may be to infer the feature that appears in an observation range of the in-vehicle sensor. As a result, it is possible to improve the accuracy of the inference processing in a scene in which the feature of an observation target of the in-vehicle sensor is inferred. It should be noted that inferring the feature that appears in the observation range may be, for example, inferring an occurrence event or inferring the attribute of the object present in the observation range. The in-vehicle sensor may be disposed toward the inside or the outside of the vehicle. The event that is the inference target may be, for example, an event that occurs in the occupant or the occurrence of the obstacle. In addition, the object that is a target for which the attribute is inferred may be present inside or outside the vehicle, and may be, for example, the occupant, the obstacle, or the traffic-related object. The inferred attribute of the object may be, for example, the state of the occupant, the state of the obstacle, or the state of the road surface.

In the machine learning, the correct answer (true value) of the task may be appropriately given. In one example, the correct answer of the task may be given by a correct answer label (teacher signal). The correct answer (true value) indicated by the correct answer label may be given manually or may be obtained by any inference processing by the computer. In this case, each training image 30 may be obtained in a format of a dataset together with the correct answer label. In another example, the correct answer of the task may be given a training index by any rule or the like.

In addition, in one example, as shown in FIG. 1, the model generation device 1 and the inference device 2 may be connected to each other via a network. A type of the network may be appropriately selected from, for example, the Internet, a wireless communication network, a mobile communication network, a telephone network, or a dedicated network. It should be noted that a method of exchanging the data between the model generation device 1 and the inference device 2 does not have to be limited to such an example, and may be appropriately selected in accordance with the embodiment. In another example, the data may be exchanged between the model generation device 1 and the inference device 2 by using a storage medium.

### 2 Configuration Example

### Hardware Configuration Example

### Model Generation Device

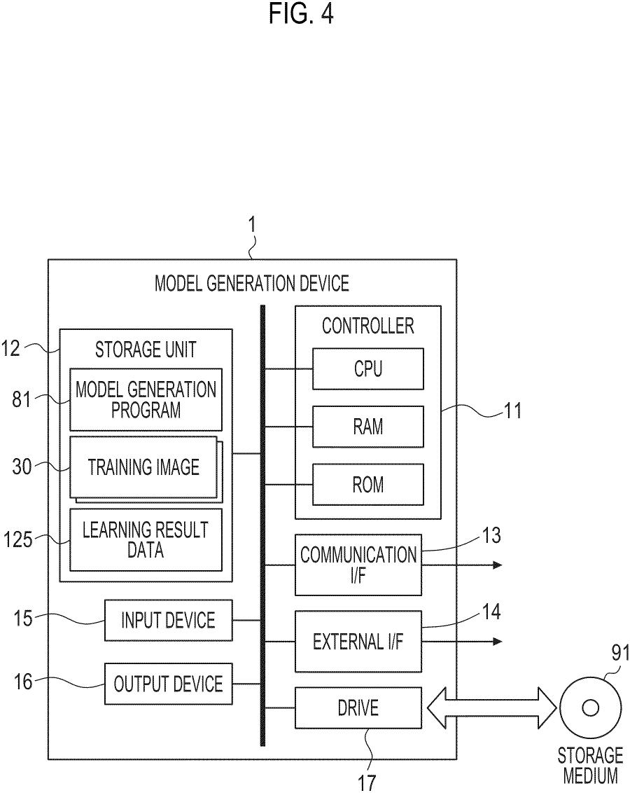

FIG. 4 schematically shows an example of a hardware configuration of the model generation device 1 according to the present embodiment. As shown in FIG. 4, the model generation device 1 according to the present embodiment is a computer in which a controller 11, a storage unit 12, a communication interface 13, an external interface 14, an input device 15, an output device 16, and a drive 17 are electrically connected to each other.

The controller 11 includes a central processing unit (CPU), a random access memory (RAM), a read only memory (ROM), and the like, and is configured to execute information processing based on a program and various data. The controller 11 (CPU) is an example of a processor resource. The storage unit 12 is composed of, for example, a hard disk drive and a solid state drive. The storage unit 12 is an example of a memory resource. In the present embodiment, the storage unit 12 stores various information, such as a model generation program 81, the training images 30, and learning result data 125.

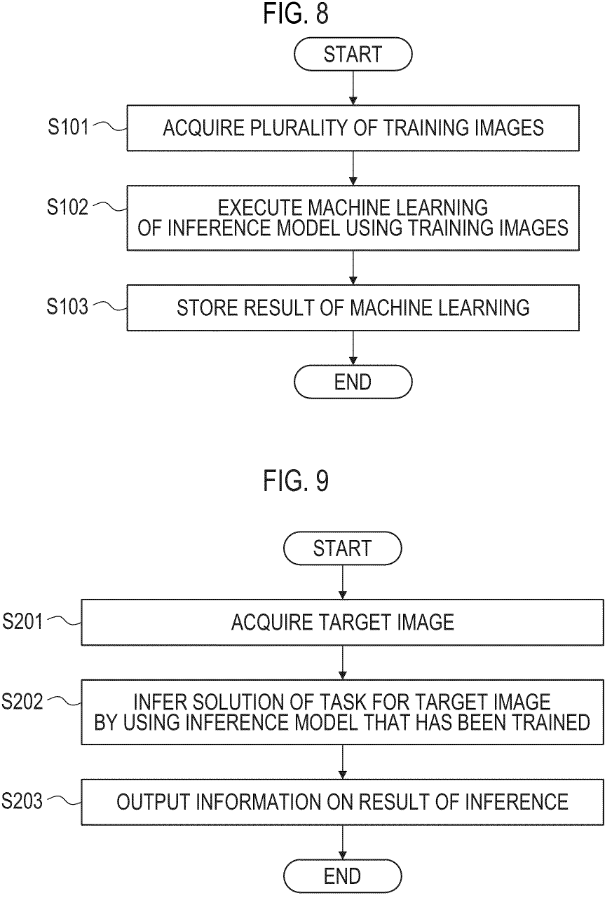

The model generation program 81 is a program causing the model generation device 1 to execute the information processing (FIG. 8 described below) of the machine learning of generating the inference model 5 that has been trained. The model generation program 81 includes a series of commands of the information processing. The training images 30 are used for the machine learning of the inference model 5. The learning result data 125 may be appropriately configured to indicate the inference model 5 that has been trained and generated by implementing the machine learning.

The communication interface 13 is, for example, a wired local area network (LAN) module or a wireless LAN module, and is an interface for performing wired or wireless communication via the network. The external interface 14 is, for example, a universal serial bus (USB) port or a dedicated port, and is an interface for connecting to an external device. A type and the number of the external interfaces 14 may be optionally determined. The model generation device 1 can execute data communication with another information processing device via the network by using the communication interface 13. In addition, the training image 30 may be acquired by the sensor. In this case, the model generation device 1 may be connected to the sensor via the communication interface 13 or the external interface 14.

The input device 15 is, for example, a device for performing input, such as a mouse or a keyboard. The output device 16 is, for example, a device for performing output such as a display or a speaker. An operator can operate the model generation device 1 by using the input device 15 and the output device 16. The training image 30 may be acquired by the input of the operator via the input device 15. The input device 15 and the output device 16 may be integrally configured by, for example, a touch panel display.

The drive 17 is a device for reading various information, such as a program stored in a storage medium 91. At least one of the model generation program 81 and the training images 30 may be stored in the storage medium 91. Accordingly, the model generation device 1 may acquire at least one of the model generation program 81 and the training images 30 from the storage medium 91. The storage medium 91 is a medium that accumulates information, such as the program, by an electrical, magnetic, optical, mechanical, or chemical action such that the computer, other devices, machines, and the like can read various information, such as the stored program.

Here, FIG. 4 shows a disk type storage medium, such as a CD or DVD, as an example of the storage medium 91. However, a type of the storage medium 91 is not limited to the disk type, and may be other than the disk type. Examples of the storage medium other than the disk type include a semiconductor memory, such as a flash memory. A type of the drive 17 may be appropriately selected in accordance with the type of the storage medium 91.

It should be noted that, for a specific hardware configuration of the model generation device 1, components can be appropriately omitted, replaced, or added in accordance with the embodiment. For example, the controller 11 may include a plurality of hardware processors. The hardware processor may be composed of a microprocessor, an electronic control unit (ECU), a field-programmable gate array (FPGA), or a graphics processing unit (GPU). At least one of the communication interface 13, the external interface 14, the input device 15, the output device 16, and the drive 17 may be omitted. The model generation device 1 may be composed of a plurality of computers. In this case, the hardware configurations of the computers may or may not match. In addition, the model generation device 1 may be a general-purpose server device, a personal computer (PC), or the like, in addition to an information processing device designed exclusively for the provided service.

### Inference Device

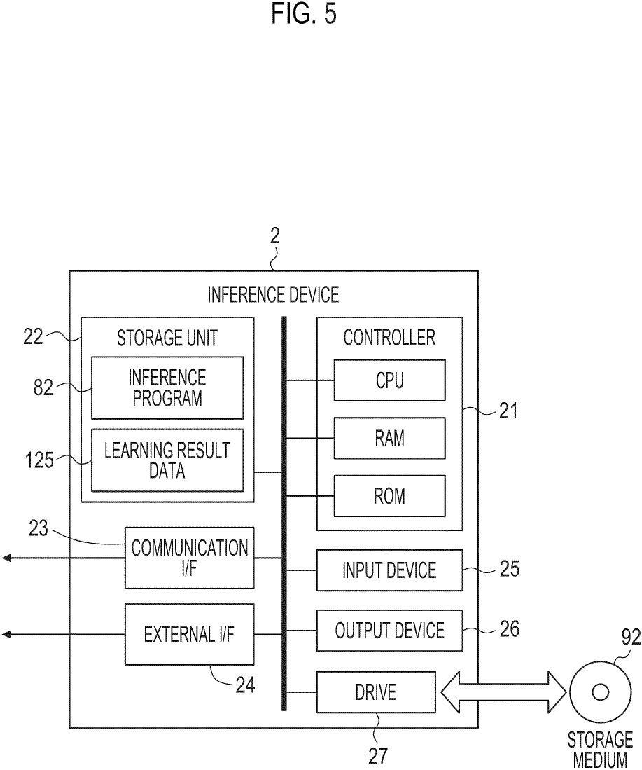

FIG. 5 schematically shows an example of a hardware configuration of the inference device 2 according to the present embodiment. As shown in FIG. 5, the inference device 2 according to the present embodiment is a computer in which a controller 21, a storage unit 22, a communication interface 23, an external interface 24, an input device 25, an output device 26, and a drive 27 are electrically connected to each other.

The controller 21 to the drive 27 of the inference device 2 and a storage medium 92 may be configured in the same manner as the controller 11 to the drive 17 of the model generation device 1 and the storage medium 91, respectively. The controller 21 includes a CPU, a RAM, a ROM, and the like that are hardware processors, and is configured to execute various information processing based on the program and data. The storage unit 22 is composed of, for example, a hard disk drive and a solid state drive. In the present embodiment, the storage unit 22 stores various information, such as an inference program 82 and the learning result data 125.

The inference program 82 is a program causing the inference device 2 to execute information processing (FIG. 9 described below) of performing the inference task for the image by using the inference model 5 that has been trained. The inference program 82 includes a series of commands of the information processing. At least one of the inference program 82 and the learning result data 125 may be stored in the storage medium 92. Accordingly, the inference device 2 may acquire at least one of the inference program 82 and the learning result data 125 from the storage medium 92.

It should be noted that, for a specific hardware configuration of the inference device 2. components can be appropriately omitted, replaced, or added in accordance with the embodiment. For example, the controller 21 may include a plurality of hardware processors. The hardware processor may be composed of a microprocessor, an ECU, an FPGA, a GPU, or the like. At least one of the communication interface 23, the external interface 24, the input device 25, the output device 26, and the drive 27 may be omitted. The inference device 2 may be composed of a plurality of computers. In this case, the hardware configurations of the computers may or may not match. In addition, the inference device 2 may be a general-purpose server device, a general-purpose PC, a tablet PC, a portable terminal (for example, a smartphone), an in-vehicle device, or the like, in addition to an information processing device designed exclusively for the provided service.

### Software Configuration Example

### Model Generation Device

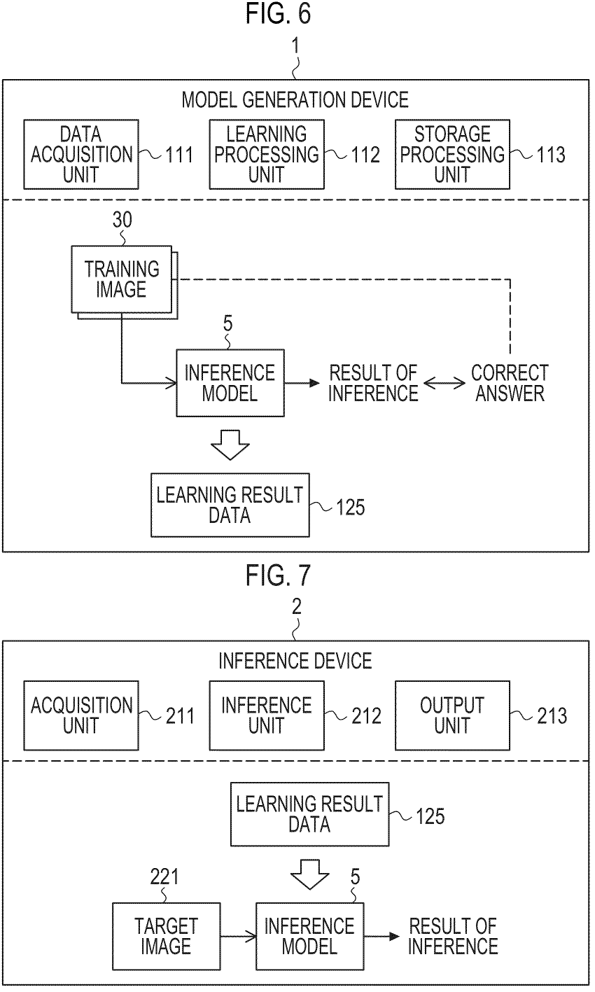

FIG. 6 schematically shows an example of a software configuration of the model generation device 1 according to the present embodiment. The controller 11 of the model generation device 1 expands the model generation program 81 stored in the storage unit 12 into the RAM, and executes the command included in the model generation program 81 expanded in the RAM by the CPU. As a result, the model generation device 1 according to the present embodiment is operated as a computer including a data acquisition unit 111, a learning processing unit 112. and a storage processing unit 113 as software modules. That is, in the present embodiment, each software module of the model generation device 1 is realized by the controller 11 (CPU).

The data acquisition unit 111 is configured to acquire the training images 30. The learning processing unit 112 is configured to implement the machine learning of the inference model 5 using the acquired training images 30. In the present embodiment, the inference model 5 includes the compression module 50 and the inference module 55. Implementing the machine learning includes training the inference model 5 such that the result of inference obtained by the inference module 55 by inputting each training image 30 to the inference model 5 as the input image 6 matches the correct answer of the task for the subregion in each training image 30.

The inference model 5 is composed of the machine learning model having the parameters adjusted through the machine learning. Training the inference model 5 includes adjusting (optimizing) the values of the parameters included in the inference model 5 such that the output (result of inference) that matches each training image 30 can be derived from each training image 30. In the present embodiment, both the compression module 50 and the inference module 55 may include one or more parameters, and adjusting the values of the parameters of the inference model 5 may include adjusting the values of the one or more parameters of the compression module 50 and the inference module 55. A method of the machine learning may be appropriately selected in accordance with the type of the machine learning model to be adopted and the like. As the method of the machine learning, for example, an error backpropagation method or a method of solving an optimization problem may be adopted.

In the present embodiment, the inference model 5 (compression module 50 and inference module 55) may be composed of the neural network. In this case, the result of inference for the subregion in each training image 30 can be obtained as the output of the inference module 55 by inputting each training image 30 to the inference model 5 as the input image 6, and executing forward operation processing of the compression module 50 and the inference module 55. The learning processing unit 112 is configured to adjust the values of the parameters of the inference model 5 such that an error between the result of inference obtained for the subregion in each training image 30 and the correct answer is small in machine learning processing.

The storage processing unit 113 is configured to generate information on the inference model 5 that has been trained and generated through the machine learning as the learning result data 125, and store the generated learning result data 125 in a predetermined storage region. As long as the inference model 5 that has been trained can be reproduced, the configuration of the learning result data 125 does not have to be particularly limited, and may be appropriately determined in accordance with the embodiment. As an example, the learning result data 125 may include information indicating the value of each parameter obtained by the adjustment of the machine learning. In some cases, the learning result data 125 may include information indicating a structure of the inference model 5. The structure may be designated by, for example, the number of layers, the type of each layer, the number of nodes included in each layer, and the connection relationship between the nodes of adjacent layers.

### Inference Device

FIG. 7 schematically shows an example of a software configuration of the inference device 2 according to the present embodiment. The controller 21 of the inference device 2 expands the inference program 82 stored in the storage unit 22 into the RAM, and executes the command included in the inference program 82 expanded in the RAM by the CPU. As a result, the inference device 2 according to the present embodiment is operated as a computer including an acquisition unit 211, an inference unit 212, and an output unit 213 as software modules. That is, in the present embodiment, each software module of the inference device 2 is also realized by the controller 21 (CPU) in the same manner as the model generation device 1.

The acquisition unit 211 is configured to acquire the target image 221. The inference unit 212 includes the inference model 5 that has been trained through the machine learning by holding the learning result data 125. The inference unit 212 is configured to infer the solution of the task for the acquired target image 221 by using the inference model 5 that has been trained. Inferring the solution of the task for the target image 221 includes acquiring the result obtained by inputting the target image 221 to the inference model 5 that has been trained, as the input image 6, and inferring the solution of the task from the inference module 55 of the inference model 5 that has been trained. In the present embodiment, the compression module 50 and the inference module 55 may each be configured to have one or more parameters. Moreover, the one or more parameters of each of the compression module 50 and the inference module 55 may be adjusted through the machine learning such that the result of inference obtained by the inference model 5 by inputting each training image 30 to the inference model 5 as the input image 6 matches the correct answer of the task for the subregion in each training image 30. The output unit 213 is configured to output information on the result obtained by inferring the solution of the task.

### Others

It should be noted that, in the present embodiment, the example is described in which each software module of the model generation device 1 and the inference device 2 is realized by the general-purpose CPU. However, some or all of the software modules may be realized by one or more dedicated processors. Each of the modules described above may be realized as a hardware module. In addition, for the software configurations of the model generation device 1 and the inference device 2, the modules may be appropriately omitted, replaced, or added in accordance with the embodiment.

### 3 Operation Example

### Model Generation Device

FIG. 8 is a flowchart showing an example of a processing procedure of the model generation device 1 according to the present embodiment. The processing procedure of the model generation device 1 described below is an example of a model generation method. It should be noted that the processing procedure of the model generation device 1 described below is merely an example, and each step may be changed as much as possible. In addition, for the following processing procedure, steps may be appropriately omitted, replaced, and added in accordance with the embodiment.

### Step S101

In step S101, the controller 11 is operated as the data acquisition unit 111 to acquire the training images 30.

Each training image 30 may be appropriately generated. The training image 30 may be obtained by the sensor. The training image 30 may be generated by the computer operation. The training image 30 may be obtained by the simulation. One or more new training images 30 may be generated by executing the operation processing of the data expansion (for example, rotation or translation) for the training image 30. In addition, the training image 30 may be generated by any operation processing of the computer.

The correct answer (true value) of the inference task for each training image 30 may be appropriately given. In one example, the correct answer label (teacher signal) indicating the correct answer may be appropriately generated, and the generated correct answer label may be appropriately associated with each training image 30. As a result, the training data may be obtained in the format of the dataset (combination of the training image 30 and the correct answer label). In another example, the correct answer of the inference task may be given by an index, such as any rule.

Each training image 30 may be automatically generated by the operation of the computer, or may be manually generated by at least partially including the operation of the operator. In addition, each training image 30 may be generated by the model generation device 1, or may be generated by the computer other than the model generation device 1. That is, the controller 11 may automatically or manually generate each training image 30. Alternatively, the controller 11 may acquire each training image 30 generated by another computer via, for example, the network, the storage medium 91. and the external storage device. Some of the training images 30 may be generated by the model generation device 1 and others may be generated by one or more other computers.

The number of the training images 30 to be acquired does not have to be particularly limited, and may be appropriately determined in accordance with the embodiment. In a case where the training images 30 are acquired, the controller 11 proceeds with the processing to next step S102.

### Step S102

In step S102. the controller 11 is operated as the learning processing unit 112, and uses the acquired training images 30 to implement the machine learning of the inference model 5.

As an example of the machine learning processing, first, the controller 11 executes initial setting of the inference model 5 that is a processing target of the machine learning. Initial values of the structure and the parameters of the inference model 5 may be given by a template or may be determined by the input of the operator. In a case where additional learning or re-learning is executed, the controller 11 may execute the initial setting of the inference model 5 based on the learning result data obtained through past the machine learning.

Next, the controller 11 trains the inference model 5 by implementing the machine learning such that the result of inference obtained for each training image 30 matches the correct answer (true value). Training the inference model 5 includes adjusting (optimizing) the values of the parameters of the inference model 5.

As an example, the controller 11 inputs each training image 30 to the inference model 5 and executes the forward operation processing. In the present embodiment, the controller 11 acquires the extensive region information from each training image 30. inputs the acquired extensive region information to the compression module 50, and executes the forward operation processing of the compression module 50. As a result of this operation processing, the controller 11 acquires the compression information.

Subsequently, the controller 11 acquires the subregion information from each training image 30, and inputs the acquired subregion information and the compression information obtained by the compression module 50 to the inference module 55. In one example, the controller 11 may generate the integrated information by integrating the subregion information and the compression information, and input the generated integrated information to the inference module 55. Moreover, the controller 11 executes the forward operation processing of the inference module 55. As a result of this operation processing, the controller 11 acquires the output corresponding to the result obtained by inferring the solution of the task for the subregion in each training image 30 from the inference module 55. It should be noted that the subregion may be appropriately designated in each training image 30. The controller 11 may repeatedly execute the series of operation processing described above for each training image 30 while changing the range designated as the subregion. As a result, the controller 11 may acquire the result of inference for the ranges in each training image 30.

Next, the controller 11 calculates the error between the obtained result of inference and the corresponding correct answer. Any loss function may be used to calculate the error. The controller 11 calculates a gradient of the calculated error. The controller 11 calculates the error of value of the parameter of the inference model 5 in order from the output side by using the gradient of the error calculated by the error backpropagation method. The controller 11 updates the value of each parameter of the inference model 5 based on each calculated error. In one example, the controller 11 may update the values of the parameters of the inference module 55 and the compression module 50.

The controller 11 adjusts the value of each parameter of the inference model 5 such that the sum of the calculated errors is small for each training image 30 by a series of update processing. For example, the controller 11 may repeat the adjustment of the value of each parameter by the series of update processing until a predetermined condition is satisfied, such as the execution is performed a predetermined number of times or the sum of the calculated errors is equal to or less than a threshold value. As a result of this machine learning processing, the controller 11 can generate the inference model 5 that has been trained and has acquired the capacity to perform the inference task on the subregion in the image. In a case where the machine learning processing is completed, the controller 11 proceeds with the processing to next step S103.

### Step S103

In step S103, the controller 1 1 is operated as the storage processing unit 113 to generate the information on the inference model 5 that has been trained and generated through the machine learning as the learning result data 125. Moreover, the controller 11 stores the generated learning result data 125 in the predetermined storage region.

The predetermined storage region may be, for example, the RAM in the controller 11, the storage unit 12, the external storage device, the storage medium, or a combination thereof. The storage medium may be, for example, a CD or a DVD, and the controller 11 may store the learning result data 125 in the storage medium via the drive 17. The external storage device may be, for example, a data server, such as a network attached storage (NAS). In this case, the controller 11 may store the learning result data 125 in the data server via the network by using the communication interface 13. In addition, the external storage device may be, for example, an external storage device connected to the model generation device 1 via the external interface 14.

In a case where the storage of the learning result data 125 is completed, the controller 11 terminates the processing procedure of the model generation device 1 according to the present operation example.

It should be noted that the generated learning result data 125 may be provided to the inference device 2 by any method and at any time. In one example, the learning result data 125 may be provided to the inference device 2 from, for example, the model generation device 1, another computer, or a data server via the network. In another example, the learning result data 125 may be provided to the inference device 2 via the storage medium 92 or the external storage device. In another example, the learning result data 125 may be incorporated in the inference device 2 in advance.

In addition, the controller 11 may update or newly generate the learning result data 125 by executing the processing of steps S101 to S103 again at any time. In a case of this re-execution, at least some of the training image 30 used for the machine learning may be appropriately changed, modified, added, deleted, or the like. The controller 11 may provide the updated or newly created learning result data 125 to the inference device 2 by any method and at any time. As a result, the controller 11 may update the learning result data 125 held by the inference device 2.

### Inference Device

FIG. 9 is a flowchart showing an example of a processing procedure of the inference device 2 according to the present embodiment. The processing procedure of the inference device 2 described below is an example of an inference method. It should be noted that the processing procedure of the inference device 2 described below is merely an example, and each step may be changed as much as possible. In addition, for the following processing procedure, steps may be appropriately omitted, replaced, and added in accordance with the embodiment.

### Step S201

In step S201, the controller 21 is operated as the acquisition unit 211 to acquire the target image 221.

The target image 221 may be appropriately generated. The target image 221 may be obtained by the sensor. The target image 221 may be generated by the computer operation. The target image 221 may be obtained by the simulation. The target image 221 may be generated by any operation processing of the computer. In one example, the controller 21 may directly acquire the target image 221 by receiving the computer operation and executing generation processing, such as the simulation. In another example, the controller 21 may acquire the target image 221 from another computer, the sensor, the storage medium 92, the external storage device, or the like. In a case where the target image 221 is acquired, the controller 21 proceeds with the processing to next step S202.

### Step S202

In step S202, the controller 21 is operated as the inference unit 212 to execute setting of the inference model 5 that has been trained with reference to the learning result data 125. Moreover, the controller 21 infers the solution of the task for the acquired target image 221 by using the inference model 5 that has been trained. The operation processing of this inference may be the same as the forward operation processing in the training processing of the machine learning. The controller 21 inputs the target image 221 to the inference model 5 that has been trained and executes the forward operation processing of the inference model 5 that has been trained. As a result of executing this operation processing, the controller 21 can acquire the result obtained by inferring the solution of the task for the subregion in the target image 221 from the inference module 55 of the inference model 5 that has been trained. It should be noted that the subregion may be appropriately designated in the target image 221. The controller 21 may repeatedly execute the series of operation processing described above for the target image 221 while changing the range designated as the subregion. As a result, the controller 21 may acquire the result of inference for the ranges of the target image 221. In a case where the result of inference is acquired, the controller 21 proceeds with the processing to next step S203.

### Step S203

In step S203, the controller 21 is operated as the output unit 213 to output information on the result of inference.

An output destination and the content of the information to be output may be appropriately determined in accordance with the embodiment. For example, the controller 21 may output the result of inference obtained in step S202 to the output device 26 or the output device of another computer as it is. In addition, the controller 21 may execute any information processing based on the obtained result of inference. Moreover, the controller 21 may output the result of executing the information processing as the information on the result of inference. The output of the result of executing this information processing may include controlling the operation of a control target device in accordance with the result of inference, and the like. The output destination may be, for example, the output device 26, an output device of another computer, or the control target device. As an example, the inference task may be to infer an event that occurs in the observation range of the in-vehicle sensor. In this case, the control target device may be the vehicle, and the controller 21 may determine an instruction to the vehicle in accordance with the result of inference and control the operation of the vehicle in response to the determined instruction. For example, in a case where the obstacle present in the vicinity of a door of the vehicle is detected by the inference, the controller 21 may output an instruction to lock the door of the vehicle to a control device of the vehicle.

In a case where the output of the information on the result of inference is completed, the controller 21 terminates the processing procedure of the inference device 2 according to the present operation example. It should be noted that the controller 21 may repeatedly execute a series of information processing in steps S201 to S203. A repeating time may be appropriately determined in accordance with the embodiment. As a result, the inference device 2 may be configured to repeatedly perform the inference task for the image.

### Feature

In the present embodiment, since the compression module 50 is provided, in the inference processing of the inference module 55, the inference model 5 can refer to the information (compression information 65) on the extensive region including the region outside the subregion, in addition to the subregion information 60 of the input image 6. As a result, the feature that appears in the subregion can be inferred based on the feature present outside the subregion, so that the accuracy of the inference processing can be expected to be improved. Therefore, by the processing of step S101 and step S102, it is possible to generate the inference model 5 that has been trained and can execute the inference processing with high accuracy. In addition, by using such an inference model 5 that has been trained in the processing of steps S201 and S202, it is possible to improve the accuracy of the inference processing for the subregion in the target image 221.

In addition, in the present embodiment, in the machine learning processing of step S102, the compression module 50 may be trained together with the inference module 55. As a result, it is possible to optimize the compression module 50 to acquire the capacity to generate the compression information 65 suitable for the inference task. That is, the compression processing by the compression module 50 can be optimized for the inference task. As a result, the accuracy of inference can be expected to be improved.

### 4 Modification Example

Although the embodiment of the present disclosure has been described in detail above, the above description is merely an example of the present disclosure in all respects. It is needless to say that various improvements or modifications can be made without departing from the scope of the present disclosure. For example, the following changes can be made. The following modification examples can be appropriately combined.

In the embodiment described above, the compression module 50 is trained through the machine learning together with the inference module 55. However, the range of the machine learning does not have to be limited to such an example. In another example, solely the inference module 55 may be a target of the machine learning, and the compression module 50 does not have to be the target of the machine learning. In this case, the compression module 50 may be configured to generate the compression information 65 by rule-based operation processing.

In addition, in the embodiment described above, the subregion information 60 and the compression information 65 may be integrated, and the inference module 55 may be configured to receive the integrated information 67. However, a form of inputting the information to the inference module 55 does not have to be limited to such an example. In another example, the inference module 55 may be configured to receive the subregion information 60 and the compression information 65. separately. In this case, the compression information 65 does not have to be the same dimension as the subregion information 60.

In addition, in the embodiment described above, the inference model 5 may include a plurality of compression modules 50. In this case, the sizes of the extensive regions to be processed by at least some the compression modules 50 may be different. In one example, each compression module 50 may be configured to generate the compression information in the same dimension as the subregion information 60 from the extensive region information having different sizes. The inference module 55 may be configured to acquire the integrated information by integrating the compression information and the subregion information 60 obtained from each compression module 50. and infer the solution of the task from the obtained integrated information.

### 5 Example

In order to verify the effectiveness of the embodiment described above, the inference models that have been trained according to following Example and Comparative Example are generated. It should be noted that the present disclosure is not limited to following Example.

First, the inference model according to Example including two compression modules and an inference module having the same configuration as the embodiment described above was prepared. Each compression module was configured to execute the operation processing shown in FIG. 3 by the neural network including the pooling layer, the convolutional layer, and the amplifiering layer. In addition, the inference module was configured to acquire the integrated information by integrating the compression information and the subregion information obtained by each compression module using the convolutional neural network, and infer the solution of the task from the obtained integrated information. On the other hand, by omitting the compression module from the configuration of Example, the inference model according to Comparative Example was prepared.

For the inference task to be performed by the inference model, the inference of the R value of each part of the component was adopted. Accordingly, the point cloud data indicating a 3D CAD model of the component was collected, and the collected point cloud data was used as the training image. Each point of the point cloud data was composed of three channels of data of the presence probability of the shape (point), the R value of a concave shape, and the R value of a convex shape. In a case where the point cloud data is used, 128 × 128 × 128 point cloud data was extracted from the point cloud data having a size equal to or more than 256 × 256 × 256. The inference models that have been trained were generated by training the inference models according to Example and Comparative Example on the personal computer under the following condition for the machine learning.

### Condition for Machine Learning

The number of training images: approximately 90,000
Subregion: 32 × 32 × 32
Estensive region processed by first compression module: 128 × 128 × 128
Extensive region processed by second compression module: 64 × 64 × 64
Learning rate: variable by warm-up method (maximum value: 0.01)
Optimization algorithm: Adam

Subsequently, the point cloud data indicating a 3D CAD model of the component (model with ribs) was prepared as an evaluation image. Moreover, by using the inference models that have been trained according to Example and Comparative Example, the inference task was performed for each subregion in the evaluation image. As a result, the accuracy of inference of the inference models that have been trained according to Example and Comparative Example were evaluated

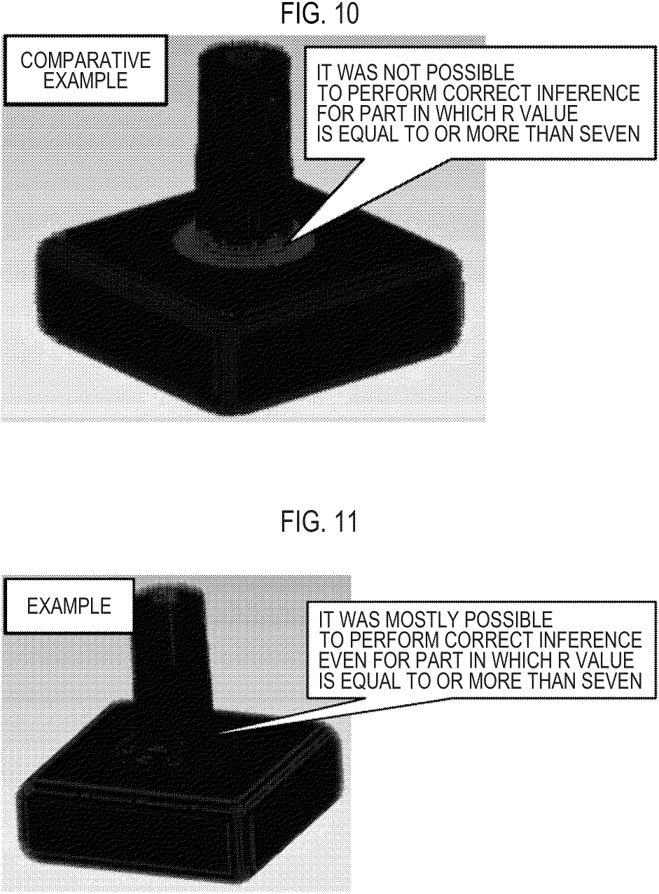

FIG. 10 shows the result of inference of Comparative Example for the evaluation image. FIG. 11 shows the result of inference of Example for the evaluation image. In FIGS. 10 and 11, a light-colored point cloud region present at a distal end of a balloon indicating portion indicates a range in which an inference error occurs. As shown in FIGS. 10 and 11, in Example, the R value of each part could be inferred more accurately than in Comparative Example. In particular, it was difficult to perform correct inference for a part in which the R value is equal to or more than seven in Comparative Example, whereas it was possible to perform correct inference even for the part in which the R value is equal to or more than seven in Example. From this result, it was found that, according to the present disclosure, it was possible to improve the accuracy of inference for the subregion in the input image.

### 6 Supplement

The processing and the means described in the present disclosure can be freely combined and implemented as long as no technical inconsistency occurs.

In addition, the processing executed by one device in the description may be allocated and executed by a plurality of devices. Alternatively, the processing executed by different devices in the description may be executed by one device. In a computer system, the hardware configuration that realizes each function can be flexibly changed.

The present disclosure can also be realized by supplying a computer program that implements the functions described in the above embodiment to a computer, and reading and executing the program by one or more processors included in the computer. Such a computer program may be provided to the computer by a non-transitory computer-readable storage medium that can be connected to a system bus of the computer, or may be provided to the computer via a network. The non-transitory computer-readable storage medium includes, for example, any type of disk, such as a magnetic disk (floppy (registered trademark) disk, hard disk drive (HDD), or the like) or an optical disk (CD-ROM, DVD disk, Blu-ray disk, or the like), a read only memory (ROM), a random access memory (RAM), an EPROM, an EEPROM, a magnetic card, a flash memory, an optical card, and any type of media suitable for storing an electronic command.

What is claimed is:

1. A model generation method executed by a computer, the method comprising:
acquiring a plurality of training images; and
implementing machine learning of an inference model using the acquired training images, wherein:
the inference model includes a compression module and an inference module configured to infer a solution of a task for a subregion in an input image;
the compression module is configured to generate compression information by acquiring information on an extensive region that includes the subregion and is wider than the subregion from the input image and compressing the acquired information on the extensive region;
the inference module is configured to derive the solution of the task from information on the subregion obtained from the input image and the compression information obtained by the compression module; and
implementing the machine learning includes training the inference model such that a result of inference obtained by the inference model by inputting each of the training images to the inference model as the input image matches a correct answer of the task for the subregion in each of the training images.

2. The model generation method according to claim 1, wherein:
the compression module includes one or more parameters;
the inference module includes one or more parameters; and
training the inference model includes adjusting values of the one or more parameters of the compression module and the inference module.

3. The model generation method according to claim 1, wherein:
the compression module is configured to generate the compression information in the same dimension as the subregion; and
the inference module is configured to generate integrated information by integrating the information on the subregion and the compression information and derive the solution of the task from the generated integrated information.

4. The model generation method according to claim 1, wherein the extensive region includes a peripheral region surrounding an entire periphery of the subregion.

5. The model generation method according to claim 1, wherein a size of the extensive region is within eight times a size of the subregion.

6. The model generation method according to claim 1, wherein:
each of the training images shows an object: and
the task is to infer an attribute of the object.

7. The model generation method according to claim 1, wherein:
each of the training images is obtained by an in-vehicle sensor; and
the task is to infer a feature that appears in an observation range of the in-vehicle sensor.

8. A model generation device comprising a controller configured to execute
acquiring a plurality of training images, and
implementing machine learning of an inference model using the acquired training images, wherein:
the inference model includes a compression module and an inference module configured to infer a solution of a task for a subregion in an input image:
the compression module is configured to generate compression information by acquiring information on an extensive region that includes the subregion and is wider than the subregion from the input image and compressing the acquired information on the extensive region;
the inference module is configured to derive the solution of the task from information on the subregion obtained from the input image and the compression information obtained by the compression module; and
executing the machine learning includes training the inference model such that a result of inference obtained by the inference model by inputting each of the training images to the inference model as the input image matches a correct answer of the task for the subregion in each of the training images.

9. The model generation device according to claim 8, wherein:
the compression module includes one or more parameters:
the inference module includes one or more parameters; and
training the inference model includes adjusting values of the one or more parameters of the compression module and the inference module.

10. The model generation device according to claim 8, wherein:
the compression module is configured to generate the compression information in the same dimension as the subregion; and
the inference module is configured to generate integrated information by integrating the information on the subregion and the compression information and derive the solution of the task from the generated integrated information.

11. The model generation device according to claim 8, wherein the extensive region includes a peripheral region surrounding an entire periphery of the subregion.

12. The model generation device according to claim 8, wherein a size of the extensive region is within eight times a size of the subregion.

13. The model generation device according to claim 8, wherein:
each of the training images shows an object; and
the task is to infer an attribute of the object.

14. The model generation device according to claim 8, wherein:
each of the training images is obtained by an in-vehicle sensor; and
the task is to infer a feature that appears in an observation range of the in-vehicle sensor.

15. An inference device comprising a controller configured to execute
acquiring a target image, and
inferring a solution of a task for the acquired target image using an inference model that has been trained through machine learning, wherein:
the inference model includes a compression module and an inference module configured to infer a solution of a task for a subregion in an input image;
the compression module is configured to generate compression information by acquiring information on an extensive region that includes the subregion and is wider than the subregion from the input image and compressing the acquired information on the extensive region;
the inference module is configured to derive the solution of the task from information on the subregion obtained from the input image and the compression information obtained by the compression module; and
inferring the solution of the task for the target image includes acquiring a result obtained by inputting the target image to the inference model that has been trained, as the input image, and inferring the solution of the task from the inference model that has been trained.

16. The inference device according to claim 15, wherein:
the compression module includes one or more parameters;
the inference module includes one or more parameters; and
values of the one or more parameters of the compression module and the inference module are adjusted through the machine learning.

17. The inference device according to claim 15, wherein:
the compression module is configured to generate the compression information in the same dimension as the subregion: and
the inference module is configured to generate integrated information by integrating the information on the subregion and the compression information and derive the solution of the task from the generated integrated information.

18. The inference device according to claim 15, wherein the extensive region includes a peripheral region surrounding an entire periphery of the subregion.
